(19) United States
(12) Patent Application Publication
(10) Pub. No.: US 2010/0199814 A1
(43) Pub. Date: Aug. 12, 2010

(54) ERGONOMIC WRENCH

(75) Inventors: Judy Lee, Taipei (TW); Tony Ho, Taipei (TW)

Correspondence Address: TSIRCOU INTELLECTUAL PROPERTY LAW, 655 Central Ave., 17th Floor, Glendale, CA, 91203, US

(73) Assignee: TEST RITE PRODUCTS CORPORATION, Ontario, CA (US)

(21) Appl. No.: 12/369,339

(22) Filed: Feb. 11, 2009

(51) Int. Cl. B25B 23/16

(52) U.S. Cl. 81/177.1

(57) ABSTRACT

An ergonomic wrench is provided that has an adjustable wrench head and an elongated handle extending from the wrench head. The handle includes a distal portion oriented transverse to the wrench head that defines a plurality of wrench apertures of different sizes. Each wrench aperture defining an axis of rotation for operable use oriented substantially transverse to the first axis of rotation. The wrench head can further include grip texture on an outer surface thereof to facilitate use of the wrench apertures defined by the wrench handle.

### FIELD OF THE INVENTION

The present invention relates generally to handheld tools and, more particularly, to wrenches.

### BACKGROUND OF THE INVENTION

Numerous handheld tools have been designed that will drive threaded fasteners. For traditional handheld designs, such tools typically have a handle extending from an end that couples with the fastener. In certain examples, the handle of the tool is oriented such that the user's hand is offset from the axis of rotation. This configuration provides a lever arm so that the user can effectively torque the fastener.

Although handheld tools are generally effective for their prescribed purposes, a user must, nonetheless, own a number of different types of tools to cover the different needs that might be encountered. For example, many wrenches seem to be either difficult to hold or do not allow adequate leverage when using. In addition, wrenches of fixed sizes are typically configured with just one or two different size heads, requiring the used to have many different wrenches.

It should, therefore, be appreciated that there remains a need for a tool that can be used across a broad range of applications. The present invention fulfills this need and others.

### SUMMARY OF THE INVENTION

The invention provides an ergonomic wrench having an adjustable wrench head and an elongated handle extending from the wrench head. The handle includes a distal portion oriented transverse to the wrench head that defines a plurality of wrench apertures of different sizes. Each wrench aperture defining an axis of rotation for operable use oriented substantially transverse to the first axis of rotation. The wrench head can further include grip texture on an outer surface thereof to facilitate use of the wrench apertures defined by the wrench handle.

In a detailed aspect of an exemplary embodiment of the invention, the outer surface that provides the grip texture is generally planar and is oriented substantially parallel to the distal portion of the handle. The grip texture can be disposed on a movable jaw of the wrench head.

In another detailed aspect of an exemplary embodiment of the invention, the handle includes a twist portion disposed between the wrench head and the distal portion. The twist portion can be positioned such that a user's thumb can rest comfortably on the twist portion while holding the wrench head portion while operating the wrench apertures.

In an exemplary embodiment, the wrench head includes a main body portion and a movable jaw that is adjustably positioned by a screw drive. Indicia can be provided on a first side depicting the size setting for the wrench head. The main body portion can be integrally formed with the elongated handle.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a perspective view of an ergonomic wrench in accordance with the invention, depicting a user holding the wrench.

FIG. 2 is a close-up perspective view of the ergonomic wrench of FIG. 1.

FIG. 3 is a front elevational view of the ergonomic wrench of FIG. 1.

FIG. 4 is a side elevational view of the ergonomic wrench of FIG. 1.

### DETAILED DESCRIPTION OF THE PREFERRED EMBODIMENTS

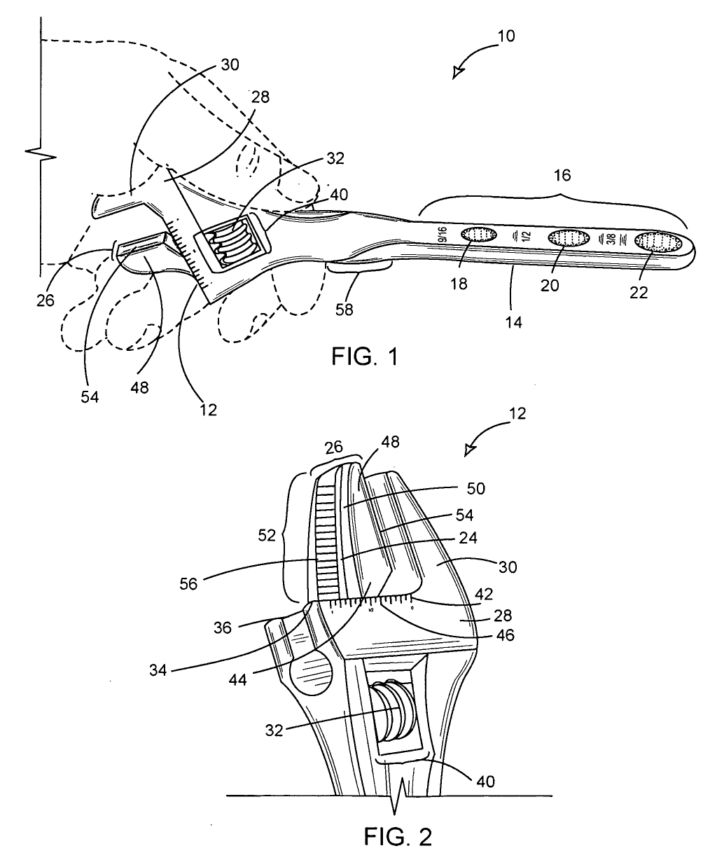

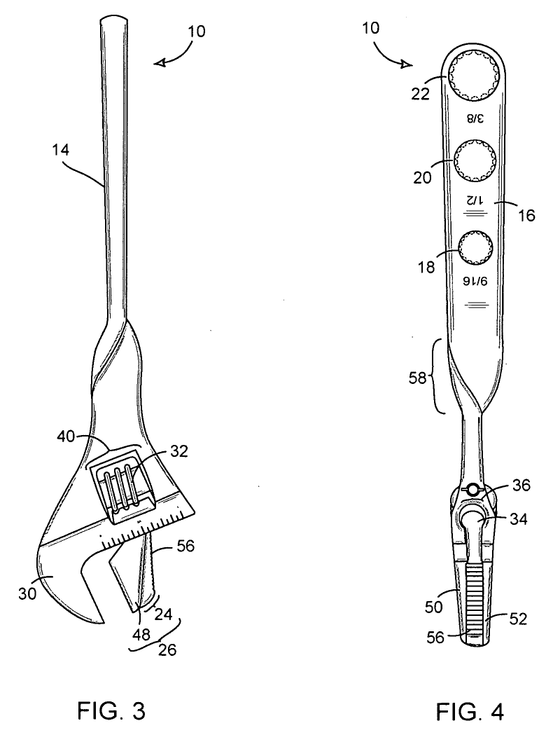

Referring now to the drawings, and particularly FIG. 1, there is shown an ergonomic wrench 10 having an adjustable wrench head 12 and an elongated handle 14 extending from the wrench head. The elongated handle includes a distal portion 16 oriented substantially transverse to the wrench head. The distal portion of the handle defines a plurality of wrench apertures (18-22). In the exemplary embodiment, box-type wrench heads, also referred to as ring spanners, are shown. A gripping portion 24 is defined on an outer surface of a movable jaw 26 of the wrench head. In this manner, the user is provided with a firm grip for operating any of the plurality of wrench apertures.

The wrench head 12 includes the movable jaw 26 and a main body portion 28. The main body portion includes a stationary jaw 30 in opposed relationship to the movable jaw. The wrench head further includes a screw drive mechanism 32 for adjusting the position of the movable jaw relative to the stationary jaw. More particularly, movable jaw includes a rod 34 positioned within a channel 36 defined by the main body portion. The rod includes a plurality of teeth 38 that interact with the screw drive mechanism to adjust the movable jaw. The screw drive is positioned within an opening 40 disposed below the channel 36.

With reference now to FIG. 2, the wrench head 12 further includes indicia 42 providing a marker 44 on the movable jaw and a scale 46 on a sidewall of the main body. The marker 44 and the scale 46 work in conjunction to indicate the size of the opening defined between the movable jaw 26 and the stationary jaw 30. In exemplary embodiment, scale provides a range between zero and one inch, in 1/16th of an inch increments. In this manner, a user can precisely set the size of the opening between the movable jaw and the stationary jaw. In other embodiments, other sizes of openings and indicia can be used without departing from the invention. In addition, indicia can be provided on a second side of the wrench head, for example, to provide a second measurement system (e.g., metric measurements).

The movable jaw 26 includes a primary jaw portion 48 and an outer portion 50 that defines the ridged gripping portion 24. The outer portion has a thickness (tₒ) less than a thickness (tₚ) of the primary jaw portion. The outer portion is generally wedge-shaped such that the outer surface 52 of the gripping portion tapers relative to the engaging surface 54 of the main jaw portion. In the exemplary embodiment, the outer surface of the gripping portion includes a plurality of ridges 56 oriented to extend across the thickness of the outer portion. In addition, the outer surface 52 of the gripping portion is generally planar and is substantially parallel to the distal portion 16 of the elongated handle 14.

In the exemplary embodiment, the elongated handle 14 includes a twist portion 58 disposed between the wrench head 12 and the distal portion 16 and the handle. More particularly, the main body portion 28 and the handle are formed of unitary construction, such as of forged metal.

In the exemplary embodiment, the handle defines three wrench apertures (18-22) of different sizes— 9/16th inch, ½ inch, and ⅜th inch. In each of the apertures, an engaging surface includes a plurality of raised portions to engage a bolt head (not shown) in use Indicia are provided adjacent to each aperture to indicate its size. The wrench apertures are aligned along a longitudinal axis of the distal portion 16 of the handle 14. In other embodiments, the wrench apertures can vary in size and number; in addition, other embodiments the wrench apertures can be configured with other features for engagement, such as ratcheting mechanisms, or socket attachments.

It should be appreciated from the foregoing that the present invention provides an ergonomic wrench having an adjustable wrench head and an elongated handle extending from the wrench head. The handle includes a distal portion oriented transverse to the wrench head that defines a plurality of wrench apertures of different sizes. Each wrench aperture defining an axis of rotation for operable use oriented substantially transverse to the first axis of rotation. The wrench head can further include grip texture on an outer surface thereof to facilitate use of the wrench apertures defined by the wrench handle.

Although the invention has been disclosed in detail with reference only to the exemplary embodiments, those skilled in the art will appreciate that various other embodiments can be provided without departing from the scope of the invention. Accordingly, the invention is defined only by the claims set forth below.

What is claimed is:

1 An ergonomic wrench, comprising:
an adjustable wrench head defining a first axis of rotation for operable use of the wrench head, the wrench for having an outer surface defining a grip texture; and
an elongated handle extending from the wrench head, the handle including a distal portion oriented transverse to the wrench head, the distal portion defining a plurality of wrench apertures of different sizes, each wrench aperture defining an axis of rotation for operable use oriented substantially transverse to the first axis of rotation.

2. An ergonomic wrench as defined in claim 1, wherein the grip texture is disposed on a movable jaw of the wrench head.

3. An ergonomic wrench as defined in claim 1, wherein the handle includes a twist portion disposed between the wrench head and the distal portion.

4. An ergonomic wrench as defined in claim 1, wherein the distal portion defines three wrench apertures.

5. An ergonomic wrench as defined in claim 1, wherein in the wrench head includes a screw drive mechanism for adjusting the wrench size.

6. An ergonomic wrench as defined in claim 1, wherein in the wrench head includes indicia on a first side depicting the size setting for the wrench head.

7. An ergonomic wrench as defined in claim 1, wherein the wrench head includes a main body portion and a movable jaw that is adjustably positioned by a screw drive.

8. An ergonomic wrench as defined in claim 1, wherein the outer surface that provides the grip texture is generally planar and is oriented substantially parallel to the distal portion of the handle.

9. An ergonomic wrench, comprising:
an adjustable wrench head having a main body portion and a movable jaw that is adjustably positioned by a screw drive; and
an elongated handle extending from the main body portion of the wrench head, the handle including a distal portion oriented transverse to the wrench head, the distal portion defining a plurality of wrench apertures of different sizes, each wrench aperture defining an axis of rotation for operable use oriented substantially transverse to the first axis of rotation.

10. An ergonomic wrench as defined in claim 9, wherein the handle includes a twist portion disposed between the wrench head and the distal portion.

11. An ergonomic wrench as defined in claim 9, wherein in the wrench head includes indicia on a first side depicting the size setting for the wrench head.

12. An ergonomic wrench as defined in claim 9, wherein the distal portion defines three wrench apertures.

13. An ergonomic wrench as defined in claim 9, wherein a grip texture provided on an outer surface of the adjustable wrench head.

14. An ergonomic wrench as defined in claim 13, wherein the outer surface that provides the grip texture is generally planar and is oriented substantially parallel to the distal portion of the handle.

15. An ergonomic wrench, comprising:
an adjustable wrench head having a main body portion and a movable jaw that is adjustably positioned by a screw drive; and
an elongated handle integrally formed with and extending from the main body portion of the wrench head, the handle including a distal portion oriented transverse to the wrench head and a twist portion disposed between the distal portion and the main body portion of the wrench head, the distal portion defining a plurality of wrench apertures of different sizes aligned along a longitudinal axis of the distal portion, each wrench aperture defining an axis of rotation for operable use oriented substantially transverse to the first axis of rotation.

16. An ergonomic wrench as defined in claim 15, wherein in the wrench head includes indicia on a first side depicting the size setting for the wrench head.

17. An ergonomic wrench as defined in claim 15, wherein the distal portion defines three wrench apertures.

18. An ergonomic wrench as defined in claim 15, wherein a grip texture provided on an outer surface of the adjustable wrench head.

19. An ergonomic wrench as defined in claim 18, wherein the grip texture is disposed on a movable jaw of the wrench head.

20. An ergonomic wrench as defined in claim 19, wherein the grip texture is defined by a generally planar outer surface oriented substantially parallel to the distal portion of the elongated handle.
